(19) United States
(12) Patent Application Publication
(10) Pub. No.: US 2022/0250906 A1
(43) Pub. Date: Aug. 11, 2022

(54) CATALYSTS, PROCESS FOR OBTAINING AND STEAM PRE-REFORMING PROCESS OF HYDROCARBONS

(71) Applicant: Petróleo Brasileiro S.A. - Petrobras, Rio de Janeiro (BR)

(72) Inventor: Roberto Carlos Pontes Bittencourt, Rio de Janeiro (BR)

(21) Appl. No.: 17/666,272

(22) Filed: Feb. 7, 2022

(30) Foreign Application Priority Data
Feb. 8, 2021 (BR) 10 2021 002346 5

(51) Int. Cl. C01B 3/40; B01J 8/02; B01J 21/04; B01J 23/83; B01J 23/89; B01J 37/04; B01J 37/08; B01J 37/02; B01J 37/18

(52) U.S. Cl. CPC C01B 3/40; C01B 2203/1252; B01J 21/04; B01J 23/83; B01J 23/894; B01J 37/04; B01J 37/082; B01J 37/024; B01J 37/18; C01B 2203/0233; C01B 2203/107; C01B 2203/1058; C01B 2203/1614; C01B 2203/1628; C01B 2203/169; C01B 2203/1241; B01J 8/02

(57) ABSTRACT

The present invention refers to a pre-reforming catalyst comprised of nickel oxide and having platinum content between 0.01 to 0.5%, characterized in that the catalyst is resistant to deactivation by passage of steam in the absence of a reducing agent and to a process for producing hydrogen or hydrogen-rich gases.

### FIELD OF INVENTION

The present invention refers to a process for producing a nickel-based catalyst promoted with platinum and use of this catalyst in the pre-reforming of hydrocarbons.

### DESCRIPTION OF THE STATE OF THE ART

The hydrogen and the hydrogen rich gases and containing CO, called synthesis gas, are produced in large scale for use in the refining industry, in the production of ammonium, methanol, liquid hydrocarbons from the “Fischer-Tropsch” process and in several petrochemical processes and for hydrogenation of solvents, paraffins and products used in the food industry. More recently, the hydrogen has been increasingly used as fuel for vehicles associated with fuel cells.

The hydrogen and the hydrogen rich gases are currently produced industrially, mainly by means of the “steam reforming” process. The main reactions that occur in the steam reforming process are presented below:

CₙHₘ+nH₂O =nCO+(n+1/2n)H₂ (endothermic reaction) Reaction 1

CH₄+H₂O=CO+3H₂ (endothermic reaction, 206.4 kj/mol) Reaction 2

CO+H₂O=CO₂+H₂ (endothermic reaction, ×41.2 kj/mol) Reaction 3

The steam reforming process can have different configurations, influenced by the type of load and by the intended use for the hydrogen enriched gas. Said configurations can include a pre-reforming reactor installed upstream the primary reform reactor, whereby this option is particularly advantageous when the unit uses naphtha or several proportions between naphtha and natural gas as raw material, when it is desired to limit the amount of steam exported in the process or when it is intended to work with low excess steam in the process, commonly quantified by the steam/carbon ratio. The use of a pre-reforming reactor is also particularly useful when it is desired to obtain a hydrogen rich current and with suitable CO contents for use in producing liquid hydrocarbons by the Fischer-Tropsch processes.

The pre-reforming step is usually carried out in a fixed bed reactor containing a nickel-based catalyst in typical temperature conditions between 330 to 500° C., steam/carbon ratio between 1 to 3 and pressures between 10 to 40 bar. The effluent composition of this step comes close to the value foreseen by the thermodynamic balance of reactions 1 to 3.

In large scale application, herein defined as being units with a production greater than 10.000 Nm³/d, the pre-reforming catalysts are constituted by nickel oxide promoted by other materials such as alumina or magnesium oxide. A limitation of the current technique of the nickel-based pre-reforming catalysts is the deactivation due to the passage of steam in the absence of a reducing agent, which can be hydrogen, methanol, natural gas, or other hydrocarbons. This limitation results from the known fact that the passage of steam by the nickel-based pre-reforming catalyst, in typical processing conditions, that is, temperatures between 330 to 500° C. and pressures between 10 to 30 kgf/cm², causes the formation of nickel phases by the exposure to steam, which cannot be reduced once again to metallic nickel in working process conditions, leading to permanent loss of activity.

This limitation of the state of the art of the pre-reforming catalysts brings several negative consequences from the point of view of the hydrogen production process by the steam reforming, such as:

1) causes the immediate stop of the unit when there occurs some fault in the flow of the hydrocarbon load or in the flow of the reducing agent, as a protective measure for the pre-reforming catalyst. Typically, the stop procedures in this situation involve the use of interlocking logics which lead to the by-bass of the reactor, and which require costly self-activating valves or the use of quick depressurization procedures of the unit, which brings risks to the catalysts and to the equipment;

2) leads to the need for the existence of pressurized vessels with hydrogen, or vessels and systems for methanol pumping, both the reducing agents used in start or emergency procedures for protection of the pre-reformer catalyst. The maintenance of the hydrogen or methanol stocks, cause an increase in the costs of the process and the risks to safety and to the environment;

3) causes the impossibility of steam heating of the pre-reformer reactors, during the start of the unit, leading to more complex logics and with more risk to the integrity of the equipment, particularly the primary reformer, which is positioned downstream the pre-reformer, due to the potential for the occurrence of thermal shocks.

The state of the art teaches the use of noble metals in formulations of catalysts containing nickel for use in the primary reform step. As is known, the primary reform step is carried out in large scale units for producing H_{2,} defined herein as having a production that is greater than or equal to 10.000 Nm³/d in a multiplicity of tubular reactors, typically having dimensions between 10 to 12 m height and 9 to 12 cm diameter located in an oven which supplies the necessary heat to the steam reforming reactions (reaction 1 to 3). The typical reaction temperature is from 450° C. to 550° C. at the entry of the tubular reactors however, this temperature rises quickly along the tube to values in the order of 800 to 900° C. at the exit thereof. The reactions that occur are the same as those of the pre-reformer section (reactions 1 to 3), however, due to the distinct temperature the effluent composition of the reactor is distinct, as well as the requirements and characteristics of the catalysts employed. The catalysts employed in the primary reformer section do not present the restrictions of not being able to pass only steam over the catalytic bed, since due to the distinct temperature conditions, these are not subject to permanent loss of performance when exposed to a steam current and without the presence of a reducing agent, such as hydrogen or methanol, or of hydrocarbons. In fact, a known procedure in the industrial practice for the removal of coke from these catalysts is the so-called steaming, which consists in the passage of steam at temperatures in the order of 750° C. for a period of several hours. The same does not occur for the pre-reforming catalysts, which loose, permanently, their activity when submitted to the passage of steam at typical operating temperatures for the operation of the pre-reforming section, that is, between 330° C. to 500° C. The literature teaches the use of noble metals in the formulation of primary reform catalysts with several purposes, such as that of increasing the activity, reducing coke deposition or deactivation due to exposure to high temperatures. Patent WO 1999037397 discloses a catalyst comprising nickel, aluminum, lanthanum, and a precious metal element, preferably ruthenium. The catalyst thus prepared was used for the steam reforming of the hexane at a temperature of 750° C. U.S. Pat. No. 10,010,876 teaches a catalyst containing nickel, aluminum and doped with noble metals, selected from P, Rh, Ru, Ir, Pd and Au and components of the group of the lanthanides containing a spinel type structure. The catalysts thus prepared can be used for producing synthesis gas at high temperature. U.S. Pat. No. 4,988,661 teaches a steam reforming catalyst for hydrocarbons consisting of at least one nickel oxide, cobalt oxide or noble metal element of the platinum group supported in alumina and at least one element selected from the group consisting of calcium, barium, or strontium. The catalysts thus prepared has the property of retaining the surface area at high temperatures without forming species of nickel aluminate. Document BR 11 2015 006510-4 teaches the preparation of a steam reforming catalyst, based on nickel support, a method for producing a supported nickel catalyst and supported catalysts obtained by means of the preferred method. The invention additionally discloses the use of these catalysts in the steam reforming process. Patent application BR 11 2015 006510-4 mentions using platinum in the formulation of the catalyst. However, this document does not disclose the quantities of platinum used. Additionally, it teaches a hydrocarbon steam reforming catalyst and not a pre-reforming catalyst. Document PI 0903348-3 discloses a nickel-based catalyst promoted by a second metal, as well as a process for producing hydrogen in a large scale by steam reforming. The nickel-based catalyst has a second metallic element, selected from the group consisting of Pt, Pd, Ru, Rh or a mixture thereof in contents between 0.01% and 1.0%, over a support with at least 15 m2/g of specific surface area, selected from the group comprising alpha and theta-alumina, calcium and magnesium aluminates, hexa-aluminates, zirconium, lanthanum and cerium oxides, or mixtures thereof in any proportions. Although document PI 0903348-3 prepares a formulation of the nickel catalysts with low contents of platinum (0.01% and 1.0% m/m) the process evaluated is not of pre-reforming but of primary reforming. None of these teachings approaches the problem of the deactivation of the catalysts by the formation of inactive species of nickel when exposed to the presence of steam and the absence of a reducing agent in temperature conditions of the pre-reforming step, that is, between 300° C. to 550° C.

The state of the art further teaches the use of noble metals in the formulation of autothermal reforming catalysts. This process for producing synthesis gas is characterized by the addition of O₂ or air simultaneously with the steam and the hydrocarbon current in an adiabatic reactor. As an example, U.S. Pat. No. 7,150,866 discloses a catalyst containing multilayers, wherein the lower layer comprises Pt in concentrations between 0.1 to 0.5% m/m, based on the total weight of the catalyst. In another example, document U.S. 2002/0009408 teaches a catalyst containing an oxide support which can be alumina, silica or titania or a mixture thereof and a catalytic phase containing at least one metal of the group of the Pt. These teachings, however, cannot be applied to the hydrocarbon pre-reforming step, since they teach the solution to other challenges of the process, such as that of having a high combustion activity for the reaction with the O₂ and/or resistance to deactivation by exposure to high temperatures, without, however, disclosing the use thereof in the pre-reforming step, typically carried out between 330° C. to 550° C. or the use thereof in small contents to avoid the loss of activity by the exposure to the passage of steam and the absence of hydrocarbons or a reducing agent such as H₂ or methanol.

The noble metals are also used in the so-called dry reforming reaction, represented by the equation 7. One example is that of U.S. 2017/0050845 which teaches catalyst formulations containing an element, or combinations of elements, selected from Ag, Au, Co, Cr, Ir, La, Mn, Ni, Os, Pd, Pt, Re, Rh, Ru, Sc, W, Mo which is alternately exposed to a hydrocarbon current and a CO₂ current. In a second example, the patent application WO 2016 207892A1 teaches a catalyst comprising a metallic nickel sponge promoted by rhenium for the dry reforming of methane. These teachings, however, cannot be applied to the pre-reforming step of hydrocarbons, since they teach the solution to other challenges of the process, particularly the resistance to the coke accumulation, without however characterizing the use thereof in the pre-reforming step, typically carried out between 330° C. to 550° C. or the use thereof in small contents to avoid the loss of activity by the exposure to the passage of steam or the absence of hydrocarbons or a reducing agent, such as H₂ or methanol.

CH₄+CO₂=CO+2 H₂ Reaction 7

Document US2010/0147749 discloses the preparation of catalyst compositions based on nickel and at least one second metal, selected from ruthenium, platinum, palladium, rhodium, cobalt, gold, and silver on a support. The catalysts obtained are also used with a component capable of capturing sulfur such as zinc oxide or copper oxide. The catalysts are used in the steam pre-reforming process for hydrocarbons. The catalyst composition in the case of Ni—Pt is 1.67% m/m Ni and 1.5% m/m of Pt, supported in gamma-alumina by the wet impregnation method. However, there were not informed quantitative data of the deactivation of the catalysts. Particularly by the mechanism of the steam passage, formulated with nickel and a second metal for the steam pre-reforming process. Additionally, the bulk content of platinum in the formulation of the catalyst with nickel has a high value and Pt/Ni m/m ratio is close to 1.0.

The use of noble metals for the formulation of pre-reforming catalysts which are more resistant to coke deposition for the specific pre-reforming diesel steam reaction is disclosed in a literature review (BOON, J.; DIJK, E. V. Adiabatic diesel pre-reforming—Literature Survey. CN Hydrogen and Clean Fossil Fuels. ECN-E-08-046, Jul. 2008. 47 p.). The purpose of this process is to generate hydrogen for fuel cells from diesel and the noble metal is used to reduce the coke accumulation rate.

The pre-reforming catalysts are used in the steam pre-reforming process for producing hydrogen. In its turn, the hydrogen is widely used in the hydro-refining processes for adequation of the quality of the fuels, in the production of fertilizers, in the production of methanol from other chemicals, in the food industry and in the growing hydrogen market for use as fuel for vehicles.

The state of the art describes the use of Pt in catalyst formulations containing Ni for primary reforming process conditions, autothermal reforming and dry reforming, without characterizing the use thereof in the pre-reforming step, carried out typically between 330 to 550° C. so that, in small contents relating to the nickel content can avoid the loss of loss of activity by the exposure to the passage of steam or the absence of hydrocarbons or a reducing agent, such as H₂ or methanol.

The present invention refers to a catalyst, the process of production of the referred catalyst and the use thereof in the pre-reforming steam process of hydrocarbons for the production of hydrogen, with different characteristics which provide great advantages over what is disclosed by the state-of-the-art documents.

### SHORT DESCRIPTION OF THE INVENTION

The present invention refers to promoting pre-reforming catalysts based on nickel, by small contents of platinum, in a concentration in the range of 0.05 to 0.5%, preferably between 0.1 to 0.2% by weight, calculated as a metallic element in the final catalyst. This solution avoids that the pre-reforming catalyst can be easily deactivated after being exposed to the passage of steam at high temperature and high pressure. Additionally, the present invention further refers to the use of these catalysts in the steam pre-reforming process of hydrocarbons for producing hydrogen or synthesis gas.

### DETAILED DESCRIPTION OF THE INVENTION

Preliminarily, it is emphasized that the following description is taken from preferred embodiments of the invention. As will be evident to any person that is skilled in the art, however, the invention is not limited to these embodiments, but only to the scope of the protection defined in the claims.

The present invention can be applied to commercial catalysts based on nickel as active phase, by means of promoting the catalysts with a Pt content at a concentration in the range of 0.05 to 0.5%, preferably between 0.05 to 0.2% by weight, calculated as the metallic element in the final catalyst, being produced by the preparation process characterized by presenting the following steps:

1. Preparation of a solution, preferably aqueous, of an inorganic Pt salt;

2. Impregnation of the commercial catalyst containing nickel, by the technique known as pore volume (wet) or by the excess solution technique, followed by drying the material thus prepared at temperatures between 60 to 120° C. for 1 to 10 h;

3. Calcination of the static air material or in air flow between 300° C. to 500° C., for 1 to 2 hours, to obtain the pre-reforming catalyst that is resistant to deactivation by the passage of steam in the absence of hydrocarbons or a reducing agent, such as H₂ or methanol.

Optionally, the calcination step can be omitted, using in this case, preferably, salts which do not contain elements such as chloride, such as the H₂PtCl_{6,} which once released “insitu”, can lead to deactivation problems of the catalysts used in the process for producing H₂ and/or corrosion problems in lines or equipment. The commercial pre-reforming catalysts based on nickel promoted with low Pt contents, in accordance with the present invention, do not deactivate by the passage of steam in typical conditions, bringing advantages in starting the H₂ production unit or avoiding emergency procedure occurrences or even the occurrence of unscheduled stops when a fault can occur in the hydrocarbon or H₂ recycle flow.

It can further be advantageous, to include the Pt in a pre-reforming catalyst formulation based on nickel containing Pt at a concentration in the range of 0.05 to 0.5%, preferably between 0.05 to 0.2% by weight, calculated as metallic element in the final catalyst and constituted by an inorganic oxide support, selected preferably from alumina, magnesium aluminate, calcium aluminate or mixture thereof. The nickel-based catalyst can further have lanthanum and cerium, with proportions between these elements from 6 to 15:1 (by weight) between NiO and La₂O₃ and 2 to 4:1 (by weight) between Ce₂O₃ and La₂O₃ and a total content of NiO between 5 and 50% by weight, preferably between 7 and 30% by weight, being produced by the preparation process containing the following steps:

1) Preparation of a solution, preferably aqueous, of an inorganic nickel salt, preferably nitrate, acetate, or carbonate, containing lanthanum and cerium, preferably in the form of nitrates;

2) Impregnation of the inorganic oxide support by the techniques known of pore volume (wet) or by the excess solution method;

3) Drying of the inorganic oxide material impregnated with solution containing nickel by air, at temperatures from 50 to 140° C. for 1 to 24 hours;

4) Calcination of the inorganic oxide material impregnated with static air or air flow between 300 to 600° C., for 1 to 4 hours. Alternatively, the steps (2-4) can be repeated more than once until the desired NiO content is reached in the support;

5) Preparation of a solution, preferably aqueous, of an inorganic Pt salt;

6) Impregnation of the inorganic oxide material containing nickel by the known technique of pore volume (wet) or by the excess solution technique;

7) Calcination of the inorganic oxide material impregnated with static air or air flow between 350 to 650° C., for 1 to 4 hours.

The step 4 of calcination can be replaced with the direct flow reduction of a reducing agent, selected from hydrogen, formaldehyde, or methanol at temperature conditions between 300 to 800° C., for 1 to 5 h, and then cooled and submitted to an air flow at temperatures between 20 to 60° C., for 1 to 5 h, to avoid the material having a pyrophoric character when handled.

Optionally, the solution prepared in item 1 can contain Pt salt, thus it will not be necessary to carry out steps 5, 6 and 7.

The catalyst of the present invention is prepared from an inorganic oxide support having low surface acidity, preferably selected from the group consisting of alumina, calcium alum inate, magnesium alum inate or a combination of these materials. The support particles can be in several forms suitable to industrial use in the steam pre-reforming process, such as spheres, cylinders or cylinders having a central orifice (Rashing rings).

A second purpose of the present invention is to provide the use of a pre-reform ing catalyst that is resistant to deactivation by the passage of steam in the pre-reform ing step for producing hydrogen or hydrogen rich gases, such as synthesis gas or natural synthetic gas. The step can be carried out using a fixed-bed catalyst with hydrocarbon feed, selected from natural gas, liquefied petroleum gas or naphtha with boiling point of up to 250° C., in the presence of steam and H². The steam/carbon ratio is selected between 0.8 to 3.0 mol/mol, preferably between 1 to 2 mol/mol, the H₂/load ratio is selected between 0.1 to 0.3 Nm³/kg of load, preferably between 0.15 to 0.25 Nm³H₂/ kg of load, temperatures along the reactor between 300° C. to 550° C., preferably between 330° C. to 500° C., pressures between 2 to 40 kgf/cm², preferably between 20 to 30 kgf/cm² and spatial speeds between 1.200 to 2.000 h⁻¹ (based on the hydrocarbon blow and for a typical campaign time of 2 years, preferably 3 years).

### EXAMPLES

Next, so that the invention can be better understood, there are presented trials which illustrate the invention without, however, being considered as limitative.

### Example 1

This example illustrates the preparation of a pre-reforming catalyst based on nickel, lanthanum, and cerium over an alumina type support. One hundred (100) grams of theta-alumina (SPH 508F by Axens, with pore volume of 0.7 cm³/g in the shape of spheres of 3 to 4 mm diameter) was impregnated with 70 ml of aqueous solution containing 2.95 grams of La(NO₃)₃.6H₂O, 8.82 grams of Ce(NO₃)₃.6H₂O and 33.03 grams of Ni(NO₃)₂.6H₂O. The material was dried at 60° C. for 2 hours; heated in static air from 60° C. to 120° C. at the rate of 1° C./min and then to 250° C. at the rate of 1.4° C./min. The catalyst was then calcined at 450° C. for 4.5 hours, having been obtained a Ni—Ce—La/theta-alumina catalyst containing 7.6% (p/p) of NiO, 1.0% (p/p) of La₂O₃ and 3.0% p/p of Ce₂O₃%.

### Example 2

This example illustrates the use of a pre-reforming commercial catalyst having nickel contents between 40 and 60% (by weight) provided in the pre-calcined state. The commercial pre-reforming catalyst does not have platinum thus, this catalyst will be compared with the other catalysts prepared in this invention. The results are shown in Table 1.

### Example 3

This example illustrates the preparation of a pre-reforming catalyst according to the present invention. Thirty grams of the catalyst of EXAMPLE 1, previously ground in the granulometric range of 100 to 150 mesh, were impregnated by the pore volume technique with an aqueous solution containing 0.08 g of H₂PtCl₆H₂O. The material was dried at a temperature from 90 to 120° C. for 12 h and then, was air calcinated at a temperature of 450° C. for 4 h, having been obtained a pre-reforming catalyst of the Pt—Ni—Ce—La/theta-alumina type containing 0.1% (by weight) of Pt, 7.6% (by weight) of NiO, 1.0% (by weight) of La₂O₃ and 3.0% by weight of Ce₂O₃%.

### Example 4

This example illustrates the preparation of a pre-reforming catalyst according to the present invention. Thirty grams of the commercial catalyst of the pre-reformer of EXAMPLE 2, previously ground at the granulometric range from 100 to 150 mesh, were impregnated by the pore volume technique with an aqueous solution containing 0.08 g of H₂PtCl₆H₂O. The material was dried at a temperature from 90 to 120° C. for 12 h and then, air calcined at a temperature of 450° C. for 4 h, having been obtained a pre-reforming catalyst based on Ni and containing 0.1% (by weight) of Pt.

### Example 5

This example illustrates the accelerated deactivation method to which the pre-reforming catalysts used according to examples 1 to 4 were submitted by means of the passage of steam (steaming) in the absence of hydrocarbon or a reducing agent. Two grams of the materials described in examples 1 to 4 were carried to a steel reactor at a catalyst test unit. The catalyst was heated at a flow of 600 ml/min of H₂ and at a rate of 10° C./min at room temperature at 450° C., which was maintained for 2 h for reduction (activation) of the species of nickel oxide to metallic nickel. Then, the H₂ was replaced with N₂ and the unit was purged for 1 h, when it was fed with water steam. This condition of passage of water steam at 450° C. was maintained for time periods between 2 to 40 h at a pressure of 20 atm.

### Example 6

This example illustrates the excellent resistance to deactivation by the passage of steam in the absence of a reducing agent, of the catalysts prepared according to the present invention. The initial reaction activity of the steam reforming was determined by a commercial AutoChem II (Micromeritcs) equipment. The tests were carried out using 500 mg of catalyst ground at a range from 100 to 150 mesh. The trials were carried out at atmospheric pressure and at temperature of 450° C., 500° C. and 550° C. by the passage of 50 ml of a current containing 50% v/v of methane, 5% of H₂ and 45% of argonium saturated with water steam at 90° C. The effluent gases of the reactor were analyzed by gas chromatography and the activity measured by the methane conversion degree.

Table 1 shows results of the catalytic activity, expressed as methane conversion, of the materials described in the examples 1 to 4, before and after being submitted to the accelerated deactivation process by the passage of steam in the absence of hydrocarbons or a reducing agent, as described in example 5. The results show that it is possible to obtain a high resistance to deactivation by the passage of steam in the absence of reducing agents for the catalysts prepared in accordance with the present invention. Additionally, comparing examples 3 and 4, we can observe that the low content of Pt added to the nickel commercial catalyst caused a significant increase of activity, which can be explained by the mechanism of favoring a higher reduction of species of nickel oxide.

TABLE 1
results of the methane conversion activity in pre-reforming conditions
over catalysts submitted to deactivation procedure by passage
of steam in the absence of hydrocarbons or reducing gases.

| | Duration of | Methane conversion at |
|---|---|---|
| Catalyst | deactivation (h)⁽¹⁾ | 500° C. (% v/v) |
| Ni/Ce/La/theta-alumina | 0 | 31.0 |
| (example 1) | 24 | 22.5 |
| | 48 | 0 |
| Ni/commercial-support | 0 | 17.5 |
| (example 2) | 24 | 0 |
| | 48 | 0 |
| Pt/Ni/Ce/La/theta- | 0 | 32.0 |
| alumina (example 3) | 24 | 23.0 |
| | 48 | 20.0 |
| Pt/Ni/commercial | 0 | 33.4 |
| support (example 4) | 24 | 30.0 |
| | 48 | 17.2 |

Note:
⁽¹⁾as per information given in example 5.

Therefore, the nickel catalysts with low platinum content prepared according to examples 1 to 4 present for the steam pre-reforming of hydrocarbons high resistance to deactivation by the passage of steam in the absence of hydrocarbons or of a reducing agent, such as hydrogen or methanol, constituted by nickel oxide and platinum, in contents between 0.05 to 0.5% m/m, preferably between 0.05 a 0.2% m/m, based on the final catalyst.

1.-16. (canceled).

17. A steam pre-reforming catalyst, comprising:
a) an inorganic oxide support selected from alumina, magnesium aluminate, or mixture thereof;
b) a mixture of nickel, lanthanum and cerium oxides, with the total content of nickel expressed as nickel oxide (NiO), from 6 to 15:1 (w/w) between NiO and La₂O₃, and 2 to 4:1 (w/w) between Ce₂O₃ and La₂O₃, and a total NiO content between 5 to 50% w/w; and
c) platinum in a concentration in the range of 0.05 to 0.5% w/w, calculated as a metallic element in a final catalyst.

18. The steam pre-reforming catalyst of claim 17, characterized in that the mixture of nickel, lanthanum and cerium oxides has a total content of NiO between 7 and 30% w/w.

19. The steam pre-reforming catalyst of claim 17, characterized in that the platinum has a concentration in the range of 0.05 to 0.2% by weight, calculated as the metallic element in the final catalyst.

20. A process for obtaining the steam pre-reforming catalyst of claim 17, characterized by comprising the following steps:
a) preparing a solution of an inorganic salt of nickel, in the form of nitrate, acetate, or nickel carbon containing inorganic salts of lanthanum and cerium;
b) impregnating the support of inorganic oxide by a pore volume (wet spot) technique or by a method of excess solution;
c) drying the inorganic oxide material impregnated with solution containing nickel in air, at temperatures from 50 to 140° C. for 1 to 24 hours;
d) calcinating the impregnated inorganic oxide material in static air or air flow between 300 to 600° C., for 1 to 4 hours;
e) preparing a solution of an inorganic salt of platinum;
f) impregnating the inorganic oxide material containing nickel, lanthanum and cerium by the pore volume technique (wet spot) or by the excess solution technique; and
g) calcinating the impregnated inorganic oxide material in static air or air flow between 350 to 650° C., for 1 to 4 hours, to obtain the pre-reforming catalyst.

21. The process of obtaining the steam pre-forming catalyst of claim 20, characterized in that the solution prepared is aqueous.

22. The process of obtaining the steam pre-forming catalyst of claim 20, characterized in that the lanthanum and cerium salts are nitrates.

23. The process of obtaining the steam pre-forming catalyst of claim 20, characterized in that the calcination step d) can be replaced with a direct reduction step in flow with reducing agent under temperature conditions between 300 to 800° C., for 1 to 5 h, and then cooled and submitted to an air flow at temperatures between 20 to 60° C., for 1 to 5 h.

24. The process of obtaining the steam pre-forming catalyst of claim 23, characterized in that the reducing agent is selected from hydrogen, formaldehyde, or methanol.

25. A steam pre-reforming catalyst, comprising:
a) nickel as active phase; and
b) platinum in a concentration in the range of 0.05 to 0.5% w/w, calculated as a metallic element in the final catalyst.

26. The steam pre-reforming catalyst of claim 25, characterized in that the platinum has a concentration in the range from 0.05 to 0.2% w/w, calculated as the metallic element in the final catalyst.

27. A process for obtaining the steam pre-reforming catalyst of claim 25, characterized by comprising the following steps:
a) preparing a solution of an inorganic salt of platinum;
b) impregnating a commercial catalyst containing nickel in contents greater than 30% w/w, by a pore volume technique (wet spot) or by an excess solution technique, followed by drying the material thus prepared at temperatures between 60 and 120° C. for 1 to 10 h; and
c) calcinating the material in static air or in air flow between 300° C. to 500° C., for 1 to 2 hours, to obtain the pre-reforming catalyst.

28. The process of obtaining the steam pre-forming catalyst of claim 27, characterized in that the prepared solution is aqueous.

29. The process of obtaining the steam pre-forming catalyst of claim 27, characterized in that the calcination step c) is omitted through the use of salts that do not contain the chloride element.

30. A process for pre-reforming of hydrocarbons, characterized by being carried out with the catalyst of claim 17 in a fixed bed, carried out in the presence of steam with a steam/carbon ratio between 0.8 to 3.0 mol/mol, at a H₂/load ratio between 0.1 to 0.3 Nm³/g, at a temperature between 300° C. to 550° C., at a pressure between 2 to 40 kgf/cm², and at a spatial velocity between 1,200 to 2,000 h⁻¹, based on the hydrocarbon flow.

31. The process for pre-reforming of hydrocarbons of claim 30, characterized by being carried out in the presence of steam with a steam/carbon ratio between 1 and 2 mol/mol and hydrogen in a H₂/load ratio between 0.1 to 0.2 Nm³/g, at a temperature between 330° C. to 500° C., and at a pressures between 20 to 30 kgf/cm².

32. The process for pre-reforming of hydrocarbons of claim 30, characterized in that the hydrocarbon comprises natural gas, or petroleum liquefied gas or naphtha.

33. A process for pre-reforming of hydrocarbons, characterized by being carried out with the catalyst of claim 25 in a fixed bed, carried out in the presence of steam with a steam/carbon ratio between 0.8 to 3.0 mol/mol, at a H₂/load ratio between 0.1 to 0.3 Nm³/g, at a temperature between 300° C. to 550° C., at a pressure between 2 to 40 kgf/cm², and at a spatial velocity between 1,200 to 2,000 h⁻¹, based on the hydrocarbon flow.

34. The process for pre-reforming of hydrocarbons of claim 33, characterized by being carried out in the presence of steam with a steam/carbon ratio between 1 and 2 mol/mol and hydrogen in an H₂/load ratio between 0.1 to 0.2 Nm³/g, at a temperature between 330° C. to 500° C., and at a pressures between 20 to 30 kgf/cm².

35. The process for pre-reforming of hydrocarbons of claim 33, characterized in that the hydrocarbon comprises natural gas, or petroleum liquefied gas or naphtha.
